(19) United States
(12) Patent Application Publication
(10) Pub. No.: US 2003/0173371 A1
(43) Pub. Date: Sep. 18, 2003

(54) Article removing container

(76) Inventors: Junji Senda, Kanagawa (JP); Kazutake Suda, Tokyo (JP)

Correspondence Address: Mitchell P Brook, Luce Forward Hamilton & Scripps, Suite 200, 11988 EI Camino Real, San Diego, CA, 92130, US

(21) Appl. No.: 10/333,050

(22) PCT Filed: May 14, 2001
(86) PCT No.: PCT/JP01/03995

(51) Int. Cl. G07F 11/00

(52) U.S. Cl. 221/13

(57) ABSTRACT

An item taking-out container making it possible to take out small items, such as candies or chocolates, one by one is composed of a container main body equipped with an accommodating portion capable of accommodating a plurality of items of a predetermined configuration and a cover member, an opening communicating with the accommodating portion being formed at a predetermined position on the surface of the container main body, the cover member being rotatably supported with respect to the container main body in order to close the opening so as to allow opening/closing, there being provided on the back side of the cover member an item taking-out means for holding the items accommodated in the accommodating portion and taking the items out of the container main body as the cover member is opened.

### TECHNICAL FIELD

The present invention relates to an item taking-out container, which allows sweets such as candies or chocolates, accommodated in a case main body, to be taken out.

### BACKGROUND ART

JP 2000-159279 A discloses an example of a known conventional item taking-out container, which contains items like sweets and allows them to be taken out one by one. This conventional item taking-out container is designed such that sweets are stacked together in a case main body, and a doll serving as an ornament takes out the sweets one by one starting with the uppermost one.

Similar examples of an item taking-out container which allows accommodated items to be taken out one by one are disclosed in Japanese Utility Model Publication No. 42-18445, JP 7-114793 B, JP 2000-25854 A, US 4966305 B, etc.

However, the above-mentioned conventional item taking-out containers are intended for taking out items stacked together in a predetermined order, and do not allow items accommodated in an irregular fashion to be taken out one by one.

Further, when accommodating items in the container, it is necessary to stack them together regularly in a predetermined order. Thus, for example, there is a case where an infant finds it difficult to perform the operation of accommodating items in the container.

Further, in the conventional item taking-out containers, the holding members for holding the items are normally exposed, so that they are subjected to adhesion of dust.

### SUMMARY OF THE INVENTION

The present invention has been made in view of the above problems in the prior art. It is an object of the present invention to provide an item taking-out container structure, which allows small items, such as candies or chocolates, accommodated in an irregular fashion to be taken out one by one.

An item taking-out device as claimed in claim 1 of the present invention has the following features:

(A) It is composed of a container main body equipped with an accommodating portion capable of accommodating a plurality of items of a predetermined configuration and a cover member.

(B) The container main body has at a predetermined position on its surface an opening communicating with the interior of the container main body, and the cover member is provided on the container main body in order to close the opening such that it can be opened and closed.

(C) On the back surface of the cover member or in the vicinity thereof, there is provided an item taking-out means for holding an item accommodated in the container main body and taking it out of the container main body as the cover member is opened.

Further, according to claim 2, there is provided an item taking-out container as claimed in claim 1 having the following features:

(A) The container main body is provided with an attitude regulating means for regulating items accommodated in an irregular attitude into an attitude, which allows them to be held by the item taking-out means.

(B) At a predetermined position in the container main body opposed to the item taking-out means, there is provided an item retaining means for retaining the items in a state in which they have been regulated into the attitude.

Further, according to claim 3, there is provided an item taking-out container as claimed in claim 2, in which there is formed in all or a part of the bottom portion of the accommodating portion a slope descending toward the attitude regulating means and/or the item retaining means.

The item taking-out device of the present invention, constructed as described above, provides the following effects:

According to the invention of claim 1, it has an effect that it is possible to provide a novel item taking-out container having, due to the item taking-out means provided on the back surface of the cover member or operationally connected thereto, an effect to be able to take out items one by one solely by opening and closing the cover member.

Further, there is no need to put items in the accommodating portion in a regular fashion as in the case of conventional item taking-out devices. Thus, there is an effect, which cannot be seen in the conventional ones, that even an infant, for example, can easily put items in the container main body.

Further, when a toy animal, a character figure or the like is used in the item taking-out means, and its portions corresponding to arms are utilized as the holding members, there is an effect that it is fun to look at such a character figure performing the operation of taking out items.

Further, since the item taking-out means is provided on the back surface of the cover member so that it may hold an item when the cover is closed, an item can be taken out simultaneously with the opening of the cover, thus there is an effect that it can realize an operation which is fun to look at.

Further, when no item is to be taken out (that is, when the container is not used), the cover member can be kept closed, so that the holding members for holding items are relatively free from adhesion of dust, thus there is an effect that the interior of the item accommodating portion is protected against intrusion of dust.

In addition to the above, the invention as claimed in claim 2 provides the following effect that it is possible to supply items in a regulated attitude efficiently to the item retaining portion, since there is provided a means for regulating items, such as candies or chocolates, accommodated in the container in an irregular fashion into a predetermined attitude. Due to this arrangement, there is an effect that it is possible to efficiently take out items as the cover is opened and closed.

Further, according the invention of claim 3, the bottom surface of the accommodating portion accommodating items is formed as a slope descending toward the item retaining portion, thus there is an effect that it is possible to efficiently supply the items to the item retaining portion.

### BRIEF DESCRIPTION OF THE DRAWINGS

FIG. 1 is a diagram showing the outward appearance of an item taking-out container according to an embodiment of the present invention.

FIG. 2 is an exploded perspective view of an item taking-out container according to an embodiment of the present invention.

FIG. 3 is a perspective view illustrating the operation of an item taking-out container according to an embodiment of the present invention.

FIG. 4 is a sectional view of an item taking-out container according to an embodiment of the present invention.

### DESCRIPTION OF PREFERRED EMBODIMENTS OF THE INVENTION

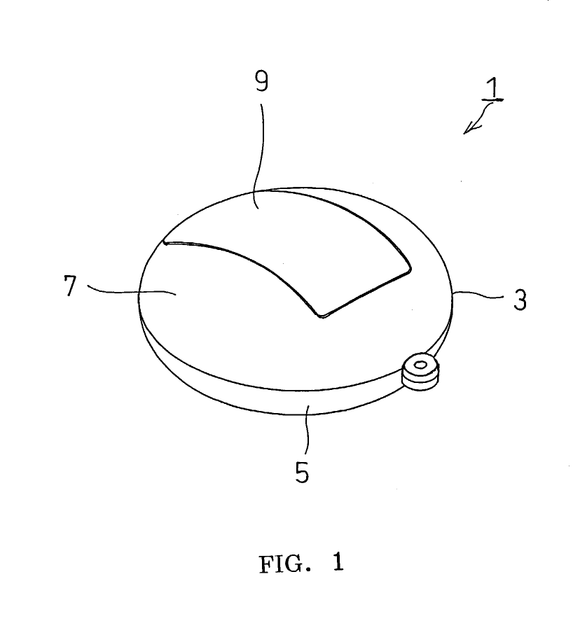

An embodiment of the present invention will be described with reference to FIGS. 1 through 4.

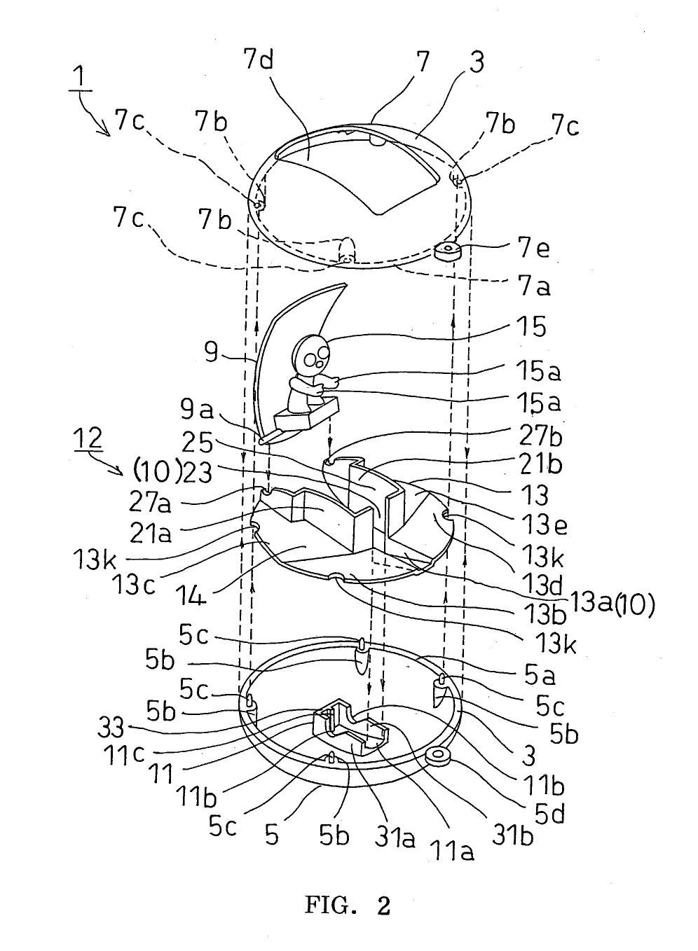

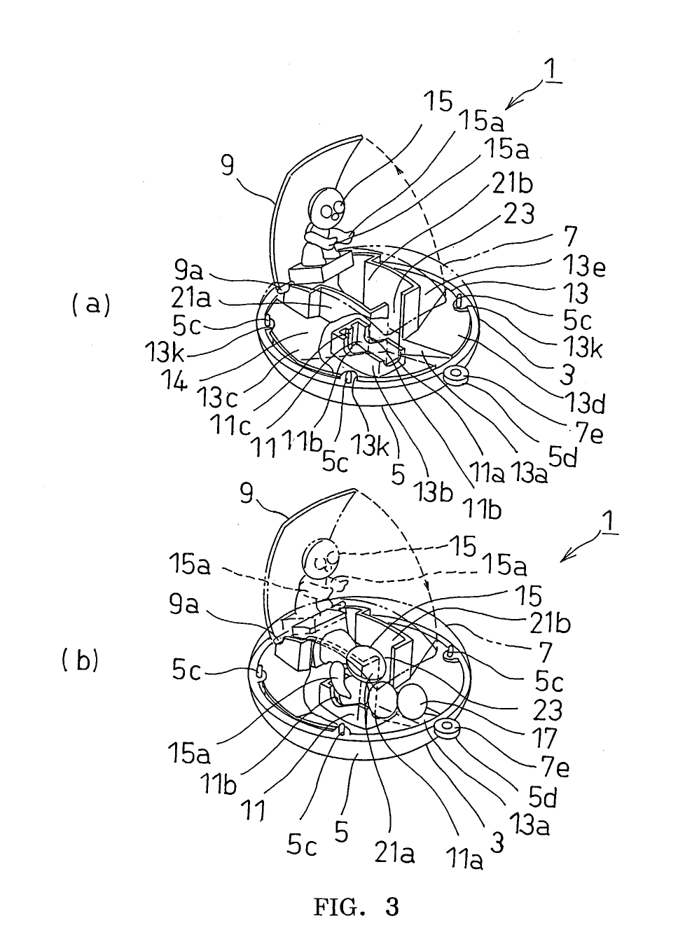

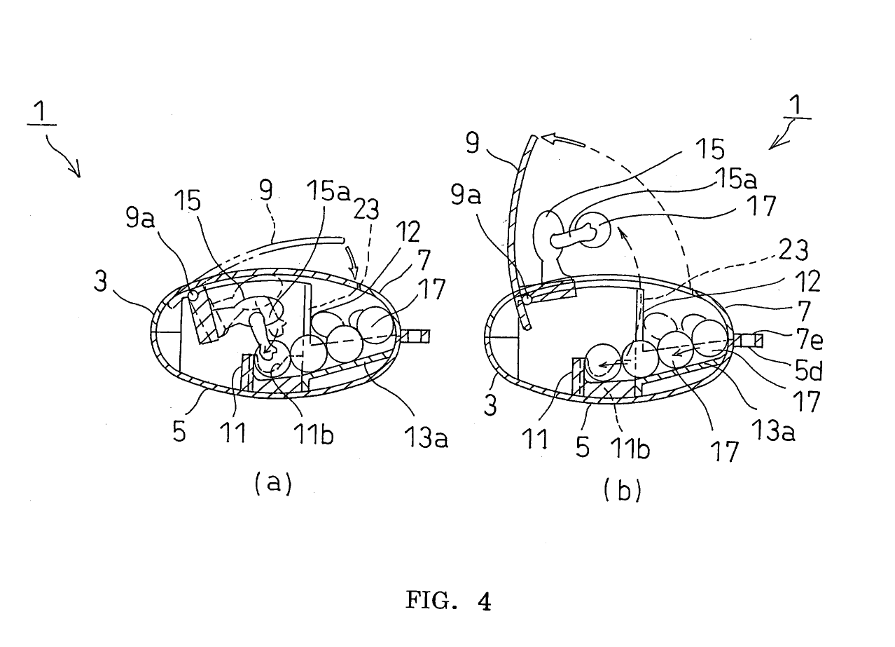

FIG. 1 is a perspective view of the outward appearance of an item taking-out container 1 according to the present invention. FIG. 2 is an exploded perspective view of the item taking-out container 1. FIG. 3 is a see-through perspective view of the item taking-out container 1. FIG. 4 is a longitudinal sectional view of the item taking-out container.

In FIGS. 1 and 2, reference numeral 3 indicates a container main body for accommodating items like sweets described below. The shell of the container main body 3 is composed of a lower container body 5 and an upper container body 7 joined thereto from above to form a hollow member having a space inside when the bodies 5 and 7 are joined together.

When the lower container body 5 and the upper container body 7 have been joined together, the container main body 3 exhibits a flat configuration as obtained by flattening a sphere from above and below. That is, as shown in the sectional view of FIG. 4 referred to below, the container main body 3 has an elliptical sectional configuration with a vertical minor axis and a horizontal major axis.

As stated above, the container main body 3 includes a space, in which items 17 consisting, for example, of solid sweets, such as candies or chocolates are accommodated.

Further, as stated above, the container main body 3 is mainly composed of the lower container body 5, the upper container body 7, and a cover member 9. Next, the lower container body 5 and the upper container body 7 will be described in detail.

In this embodiment, the items 17 have a tablet-like configuration as obtained by flattening a sphere, and each member of the container main body 3 is shaped in conformity with the configuration of the items 17. The configuration of the items is not restricted to the above-described one; it may also be a more sphere-like configuration, in which case each member is formed accordingly.

The lower container body 5 is a shell member constituting the lower half of the container main body 3, and it is a bowl-like member with an upwardly opened round opening. On the inner side of an upper edge 5a forming the opening, there are provided, at equal intervals, four inwardly directed locking protrusions 5b for locking an intermediate member 12 described below. Further, on top of the locking protrusions 5b, there are provided upwardly directed engagement protrusions 5c respectively, which protrude upwardly beyond the upper edge 5a for fitting engagement with the upper container body 7.

At one side of the upper edge 5a, there is provided an outwardly directed string-hole portion 5d, which allows the item taking-out container 1 to be suspended. When a predetermined string is passed through the string-hole portion 5d and looped, it is possible for the container 1 to be suspended from a person's neck or wrist or a hook on a wall or the like.

In the following description of this embodiment, the side where the string-hole portion 5d is provided will be referred to as the front side of the container main body 3, and the side where no string-hole portion 5d is provided will be referred to as the rear side thereof.

The upper container body 7 is a shell member constituting the upper half of the container main body 3, and it is a bowl-like member with a downwardly opened round opening. A lower edge 7a forming the opening is a portion opposed to the upper edge 5a of the lower container body 5 for joining together, and has substantially the same size as the upper edge 5a.

On the inner side of the lower edge 7a, there are provided inwardly directed predetermined protrusions 7b. The protrusions 7b are provided with engagement holes 7b opposed to engagement protrusions 5c of the lower container body 5 and adapted to be engaged therewith. Further, on the outer side of the front portion of the lower edge 7a, there is provided a string-hole portion 7e to be matched with the string-hole portion 5d of the lower container body 5.

Further, in the upper-side surface of the upper container body 7, there is formed a substantially rectangular opening 7d of a predetermined size extending a long a line connecting the front and rear sides of the container main body 3.

In the opening 7d, there is provided a cover member 9 having an external configuration substantially in conformity with the opening 7d and adapted to close the opening 7d, the cover member being capable of being opened and closed.

As stated above, the cover member 9 is intended to close the opening 7d of the upper container body 7 and is capable of being opened and closed. In this embodiment, the cover member 9 has a curved surface configuration such that, in the closed state, it is flush with the surface of the upper container body 7.

Further, at one end portion of the cover member 9, there is provided a rotation shaft 9a somewhat protruding on either side. As will be described in detail below, this rotation shaft 9a is rotatably supported by the intermediate member 12 and serves as a rotation fulcrum for the cover member 9.

Further, on the back surface of the cover member 9, there is provided an item taking-out means 15, which will be described below.

Inside the container main body 3, there are further provided an item retaining portion 11, the intermediate member 12, and an accommodating portion 14, which will be described below.

As described below, the item retaining portion 11 serves to retain one item 17 to be taken out while allowing the item to maintain a predetermined attitude, and is provided substantially at the center of the bottom of the interior of the lower container body 5.

The item retaining portion 11 is composed of a pair of right and left side walls 31 (31a and 31b) extending in the longitudinal direction, which corresponds to the front-to-rear direction of the container main body 3, and a rear wall 33 provided so as to close the rear side of the side walls, and it is formed so as to be open on the upper and front sides. As stated above, the item retaining portion 11 has on its front side an opening 11a, which serves as an inlet for the items 17. Further, the right and left side walls 31a and 31b have substantially semi-circular cutouts 11b so as to allow movement of the item taking-out means 15 (described in detail below) and undisturbed holding of an item supplied into the item holding portion 11.

The right and left side walls 31a and 31b stand upright with a distance therebetween allowing movement of the item 17 and retainment thereof in an erect attitude, that is, with a distance somewhat larger than the thickness of the item 17. Further, inside the item retaining portion 11 and substantially at the center of the inner side of the rear wall 33, there is provided an item holder 11c having a predetermined width and protruding forwards, and it serves to hold one item 17 put in the item retaining portion 11 at a predetermined position.

Further, as long as the item retaining portion 11 is able to keep the attitude of the item 17 so as to allow the item to be taken out by the item taking-out means 15, it is not always necessary for the item retaining portion 11 to be capable of securing the item 17 in position so as to prevent it from moving. It is only necessary for the item retaining portion (11) to be able to keep the item in a fixed attitude.

Next, an attitude regulating means 10 provided in the container main body 3 will be described. The attitude regulating means 10 serves to bring the item 17 accommodated in an irregular fashion into a fixed attitude, allowing the item 17 to be accommodated in the item retaining portion 11. In this embodiment, the attitude regulating means 10 is provided integrally with a member forming a bottom plate 13 of an accommodating portion 14 accommodating the item and with a partition wall 21 standing upright so as to surround the item retaining portion. In a part of the partition wall 21, there is provided a narrow opening 23 opposed to the opening 11a of the item retaining portion.

The bottom plate 13, which is formed integrally with the attitude regulating means 10, is provided with a slope or the like for causing the item 17 to slide or roll toward the item retaining portion 11. In this embodiment, the bottom plate 13 has a symmetrical configuration and is equipped with a groove 13a having a bottom surface inclined from the center of the front side toward the rear side. The groove 13a has substantially the same width as the opening 23, and the downwardly inclined bottom surface is connected to the bottom surface of the item retaining portion 11 so as not to involve any difference in level therebetween. That is, as described below, the item 17 having entered the groove 13a rolls inside the groove 13a to enter the item retaining portion 11 through the opening 23.

Further, in the front portion of the bottom plate 13 and on the left side of the groove 13a, there is provided a gentle slope 13b, which is gently inclined from the left-hand side toward the center so as to gather the items 17 in the groove 13a. Further, in the rear portion of the bottom plate 13 connected to the gentle slope 13b, there is provided a rear inclined surface 13c inclined somewhat steeply from the rear side toward the front side.

Similarly, on the right-hand side of the groove 13a, there is provided a gentle slope 13d gently inclined from the right-hand side toward the center, and, in the rear portion of the bottom plate 13 connected to the gentle slope 13d, there is provided a slope 13e inclined somewhat steeply from the rear side toward the front side.

Further, substantially at the center of the bottom plate 13, partition walls 21 (21a and 21b) stand symmetrically so as to surround the item retaining portion 11 with a predetermined gap therebetween. Due to this construction, the portion surrounded by the outer sides of the partition walls 21, the upper portion of the bottom plate 13, and the inner side of the upper container body 7 forms an accommodating portion 14 accommodating a plurality of items 17. And, the items 17 accommodated in the accommodating portion 14 move on the gentle slopes 13b and 13d and the rear slopes 13c and 13e to be gathered in the groove 13a.

As described above, the exterior of the partition walls 21 constitutes the accommodating portion 14 for the items 17, whereas the interior of the partition walls 21 constitutes an accommodating space 25 large enough to allow emerging and submerging of the item taking-out means 15 adapted to move with the opening and closing of the cover 9. In this embodiment, the space 25 is formed such that its width decreases stepwise as it extends from the rear side to the front side in conformity with the configuration of the item taking-out means 15; the above-mentioned opening 23 is formed on the front side of the space.

Further, the height of the partition walls 21 is determined such that when the cover member 9 is closed, their upper edges abut the back surface thereof, with the cover member 9 being kept in a position where it is flush with the surface of the upper container body 7. Further, in the rear portions of the upper edges of the partition walls 21, there are provided cutouts 27 (27a and 27b) serving as bearing portions for rotatably supporting the rotation shaft 9a of the cover member 9. By attaching the upper container body 7, the upper sides of the cutouts 27 are closed so that the rotation shaft 9a supported may be held so as not to come off.

The contour of the bottom plate 13 is substantially circular in conformity with the configuration of the inner-side portion of the lower container body 5 near the opening. The bottom plate 13 is attached to the inner side surface of the lower container body 5. At predetermined positions of the outer edge of the bottom plate 13, there are provided locking cutouts 13k corresponding to the locking protrusions 5b provided on the lower container body 5. The locking cutouts 13k are engaged with the locking protrusions 5b for locking, whereby the bottom plate 13 is attached to the inner surface of the lower container body 5. As stated above, in this condition, the opening 11a of the item retaining portion 11, the groove 13a of the bottom plate 13, and the opening 23 are matched with each other in position.

Next, the item taking-out means 15 will be described.

The item taking-out means 15 is provided at a predetermined position on the back surface of the cover member 9, and has a pair of arm-like holding members 15a. In this embodiment, the item taking-out means 15 consists of an ornament in the form of a toy animal or an animated-film character or the like, the portions corresponding to the arms of the character constituting the pair of holding members 15a.

The holding members 15a consist of flexible members adapted to hold therebetween the item 17 arranged in the item retaining portion 11. In this embodiment, the distance between the holding members 15a is, for example, approximately 5 mm, which corresponds to the thickness of the item 17.

That is, when the cover member 9 provided with the item taking-out means 15 is closed, the item taking-out means 15 holds one item 17 placed at a predetermined position of the item retaining portion 11, and as the cover member 9 is opened, the item 17 held can be taken out of the item taking-out means 15.

Next, the way a plurality of items 17 accommodated in the item taking-out container 1 constructed as described above are taken out one by one will be described.

By depressing the rear portion of the cover member 9 of the item taking-out container 1, the front portion of the cover member 9 is raised, and the cover member 9 is opened. When the cover member 9 has been opened, the items 17 to be taken out one by one later on are put in the exterior of the partition walls 21a and 21b (the accommodating portion 14) through the opening 7d of the cover member 9.

By lightly shaking or swaying the container main body 3, the first one of the items 17 accommodated in the accommodating portion 14 is caused to slide into the groove 13a from the rear slope 13c, 13e and the gentle slope 13b, 13d. At this time, the first item 17 is guided by the groove 13a and rolls on the inclined bottom surface thereof to be supplied to the item retaining portion 11 through the opening 23. In this way, the groove 13a and the opening 23 serve as the attitude regulating means for regulating the item 17 into a position allowing it to be held by the holding members 15a and supplying it to the item retaining portion 11.

Subsequently, two or three items 17 successively slide down into the groove 13a from the rear slopes 13c and 13e and the gentle slopes 13b, 13d, and a state is attained in which the items are aligned in the groove 13a to be supplied to the item retaining portion 11.

When, in the state in which the item 17 has been supplied to the item retaining portion 11, the cover member 9 is closed on the container main body 3, the holding members 15a of the item taking-out means 15 provided on the back side of the cover member 9 are rotated downwardly to draw an arc to hold the first item 17, as shown in FIGS. 3(a) and 4(a). As described above, the cutouts 11b are provided in the side walls 31a and 31b of the item retaining portion 11, and gaps are provided between the item retaining portion 11 and the partition walls 21a and 21b, whereby the holding portions 15a of the item taking-out means 15 holds the portion of the item 17 where its width is substantially maximum without coming into contact with the item retaining portion 11 and the partition walls 21a and 21b.

Further, since no unnecessary item 17 is allowed to enter the space surrounded by the partition walls 21a and 21b, there is no danger of the unnecessary item 17 hindering the rotation of the item taking-out means 15.

Next, when the cover member 9 is opened again, the pair of holding portions 15a of the item taking-out means 15 moves upwardly from below to draw an arc while holding the first item 17, and takes the item 17 out of the container main body 3 (See FIGS. 3(b) and 4(b)).

On the other hand, as soon as the first item 17 accommodated in the container main body 3 is taken out, the item retaining portion 11 becomes empty, so that the next item 17 in the groove 13a is supplied to the item retaining portion 11. Since two or three items 17 stand in a row in the groove 13a, each time an item 17 is taken out, another item 17 slides down into the groove 13a from the rear slope 13c, 13e and the gentle slope 13b, 13d, and an item 17 is supplied to the item retaining portion 11.

In this way, the items 17, which are in irregular attitudes in the accommodating portion 14 of the container main body 3, are regulated into a fixed attitude as they pass through the opening 23 after entering the groove 13a from the rear slopes 13c and 13e and the gentle slopes 13b and 13d before being supplied to the item retaining portion 11. When, in this condition, the cover member 9 is closed and opened, it is possible to take out one by one the items 17 accommodated in the accommodating portion 14 in an irregular fashion.

While in the above-described embodiment the cover member 9 has a rectangular configuration, this should not be construed restrictively.

Further, while in the above embodiment the item taking-out means is fixed to the back surface of the cover, it is also possible to adopt some other construction as long as it consists of a mechanism in which the opening/closing of the cover is operationally connected with the item taking-out means.

Further, while in the above embodiment the items to be taken out by the item taking-out means have a tablet-like configuration as obtained by flattening a sphere, they may also be of a spherical or an annular configuration; there is no particular restriction regarding the item configuration as long as it allows regulation into a predetermined attitude.

The present invention provides a technique applicable to an item taking-out container, which allows sweets, such as candies or chocolates, accommodated in a case main body, to be taken out.

1. An item taking-out device comprising:
(A) a container main body equipped with an accommodating portion capable of accommodating a plurality of items of a predetermined configuration, and a cover member;
(B) an opening communicating with the interior of said container main body formed at a predetermined position on the surface of the container main body, wherein said cover member is provided on said container main body in order to close the opening such that it can be opened and closed;
(C) an item taking-out means provided on the back surface of said cover member or in the vicinity thereof for holding an item accommodated in said container main body and taking it out of the container main body as said cover member is opened.

2. An item taking-out device as provided in claim 1, comprising:
(A) an attitude regulating means, provided on said container mainbody, for regulating items accommodated in an irregular attitude into an attitude that allows the items to be held by said item taking-out means;
(B) an item retaining means, provided at a predetermined position in the container main body opposed to said item taking-out means, for retaining the items in a state in which they are regulated into said attitude.

3. An item taking-out device as provided in claim 2, comprising a slope descending toward said attitude regulating means and/or the item retaining means formed on all or a part of the bottom portion of said accommodating portion.
